(19) United States
(12) Patent Application Publication
(10) Pub. No.: US 2015/0211577 A1
(43) Pub. Date: Jul. 30, 2015

(54) ROLLER BEARING CAGE, ROLLER BEARING, AND ELECTRIC STEERING FOR A MOTOR VEHICLE

(71) Applicant: AKTIEBOLAGET SKF, Goteborg (SE)

(72) Inventors: Thierry Adane, Tours (FR); Thomas Perrotin, Saint Roch (FR); Laurent Varnoux, Saint-Avertin (FR)

(21) Appl. No.: 14/423,421

(22) PCT Filed: Aug. 14, 2013
(86) PCT No.: PCT/EP2013/066981

§ 371 Date: Mar. 25, 2015

(30) Foreign Application Priority Data
Aug. 22, 2012 (FR) 1257933

(51) Int. Cl. F16C 33/46; F16C 19/06

(52) U.S. Cl. CPC F16C 33/467; F16C 33/4676; F16C 33/4635; F16C 19/06

(57) ABSTRACT

A cage for a bearing for electric steering for a motor vehicle. The cage is designed to provide circumferential spacing of a row of roller elements, including an annular heel axially extended by separating portions that define cavities for the roller elements therebetween. The cavities radially extending from either side of the cage. The inner diameter of the separating portions is greater than the inner diameter of the annular heel.

### CROSS REFERENCE TO RELATED APPLICATIONS

This is a National Stage Application claiming the benefit of International Application Number PCT/EP2013/066981 filed on 14 Aug. 2013 (14.08.2013), which claims the benefit of French Patent Application Serial Number 1257933, filed on 22 Aug. 2012 (22.08.2012), both of which are incorporated herein by reference in their entireties.

### TECHNICAL FIELD

The present invention relates to the field of rolling bearings, notably the rolling bearings used in motor vehicle electric power steering.

More specifically, the invention relates to the retention cages which ensure a circumferential spacing between rolling elements of rolling bearings.

### BACKGROUND OF THE INVENTION

A motor vehicle electric power steering generally comprises an electromechanical actuator situated on the steering column or on the lower assembly which comprises mechanical components intended to ensure the angular positioning of the steered wheels of the vehicle. The electromechanical actuator comprises a rotary electric motor the shaft of which is supported by at least one four-point contact ball bearing device either directly, or via a ball screw system.

The rolling bearing generally comprises an inner ring, an outer ring and a row of rolling elements, generally balls, which is arranged between the rings.

Rolling-bearing ball-retaining cages made of synthetic material, comprising pockets to house the balls, are known from document FR 2 921 451. The pockets are separated by claws arranged in pairs, on the opposite side to a heel extended axially by a dividing portion having an inside diameter substantially equal to the inside diameter of the heel, so that in cross-section it forms an L-shape. Such retaining cages are entirely satisfactory in many applications. However, in applications involving low rotational speed or those in which the direction of rotation reverses sharply, this kind of cage runs into various difficulties. Specifically, under the effect of the loading of the balls, the cage may suffer extensive deformation and come into contact with the inner ring, causing it to become damaged or even destroyed.

In addition, when the direction in which the load is applied to the rolling bearing changes, as it does for example when the wheels of a vehicle equipped with an electric power steering system as described hereinabove are turned as the driver maneuvers to the left and to the right in order to park the vehicle, the cage is likewise severely deformed, or even destroyed.

Finally, the centrifugal force as the rolling bearing rotates throws the lubricant contained in the rolling bearing outward. Such cages are unable to retain the lubricant.

Reference may also be made to documents FR 2 900 996 and FR 2 911 934 which describe a rolling-bearing cage for high-speed applications, the dividing portion of which is likewise L-shaped. However, when the rolling bearing is used at low speed, the L shape of the dividing portion would come into contact with the inner ring and this would cause it to become damaged or even destroyed.

This is because when a cage is used at low speed, the cage deforms inward when it comes into a zone of axial and radial load. The cage is therefore subjected to torsion forces and severe banking, notably when the rolling bearing slows down suddenly, causing the rolling element to press suddenly against the pocket in which it is housed.

The present invention therefore seeks to overcome these disadvantages.

More particularly, the present invention seeks to provide a rolling bearing cage for low-speed applications that is not very deformable, is of restricted size, and provides good distribution of stress across the cage.

The present invention also seeks to provide a cage that allows the lubricant present in the rolling bearing to be recovered.

### SUMMARY OF THE INVENTION

One subject of the invention is a motor vehicle electric power steering rolling bearing cage intended to ensure the circumferential spacing of a row of rolling elements, comprising an annular heel extended axially by dividing portions between them defining pockets for the rolling elements opening radially on either side of the cage.

The inside diameter of the dividing portions is greater than the inside diameter of the annular heel.

Thus, as the dividing portions have an inside diameter greater than the inside diameter of the heel they are not made to come into contact with the inner ring, as the rolling bearing rotates. The cage therefore has an extended life. In addition, the lubricant present in the rolling bearing is recovered by the dividing portions so that it can be distributed to the rolling elements.

Advantageously, the outside diameter of the dividing portions is less than or equal to the outside diameter of the annular heel. Thus, the cage in cross section has a gamma “Γ” or “T” shape.

According to one embodiment, the cage comprises at least one first pocket provided with axial retention means for retention of the cage on a rolling element.

The dividing portions situated between two adjacent first pockets may comprise two claws the free end of which extends in the circumferential direction toward the claw of the adjacent dividing portion to form one of the first pockets.

According to another embodiment, the cage comprises a plurality of second pockets that do not have axial retention means for retention of the cage on a rolling element.

Advantageously, the dividing portions situated between a first pocket and a second pocket comprise a claw the free end of which extends in the circumferential direction toward the claw of the adjacent dividing portion to form one of the first pockets and a cylindrical protuberance forming, with the cylindrical protuberance of the adjacent dividing portion, one of the second pockets.

According to one embodiment, the dividing portions comprise a recess made on the internal face of the dividing portion.

The annular heel may have an opening in the thickness of the heel opening axially between a face of the heel which is the opposite face to the rolling elements, and the recess of the dividing portions.

The presence of an opening in the heel and in the dividing portion allows the cage to be mounted more easily on the rolling elements, thanks to the increase in the flexibility of the dividing portions. In addition, the weight and the cost of manufacture are less.

The first pockets are, for example, provided with substantially spherical walls and the second pockets are, for example, provided with substantially cylindrical walls.

The cage may be made of synthetic material, preferably a polymer material.

A second aspect of the invention relates to a rolling bearing comprising an outer ring, an inner ring each one comprising at least one raceway, a row of rolling elements which are arranged between the raceways and a cage as described hereinabove.

The rolling elements may be balls.

A third aspect of the invention relates to an electric power steering comprising at least one rolling bearing as described hereinabove.

### BRIEF DESCRIPTION OF THE DRAWINGS

The present invention will be better understood from reading the description of some embodiments which are given by way of entirely nonlimiting examples and illustrated by the attached drawings in which:

FIG. 1 is a perspective view of a rolling bearing according to a first embodiment of the invention;

FIG. 2 is a view in cross section of the rolling bearing according to FIG. 1;

FIG. 3 is a perspective view of a cage according to FIG. 1;

FIG. 4 is a perspective view of a cage according to a second embodiment of the invention;

FIG. 5 is a perspective view, from the rear, of the cage according to FIG. 4;

FIG. 6 is a view in cross section of a rolling bearing according to a third embodiment of the invention;

FIG. 7 is a perspective view of a cage according to a fourth embodiment of the invention; and

FIGS. 8 and 9 are views in section of a rolling bearing comprising a cage according to FIG. 7.

### DETAILED DESCRIPTION OF EMBODIMENTS

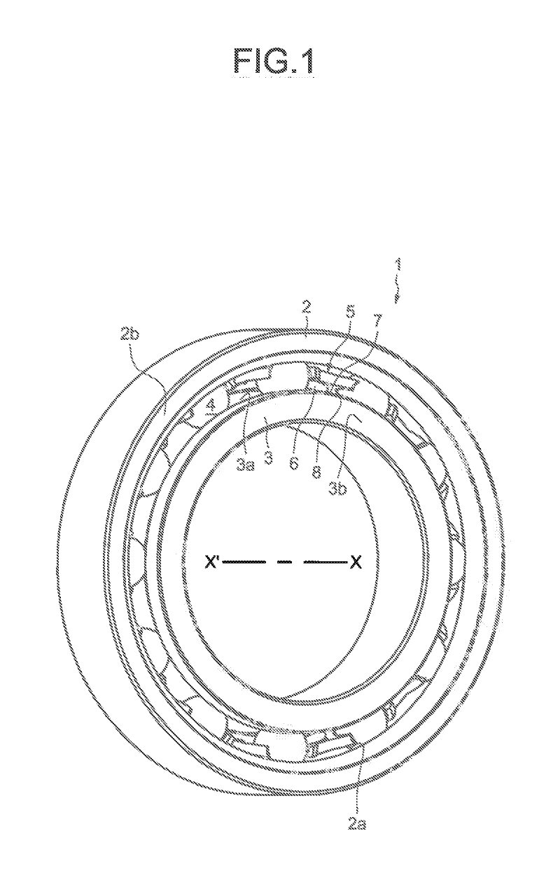

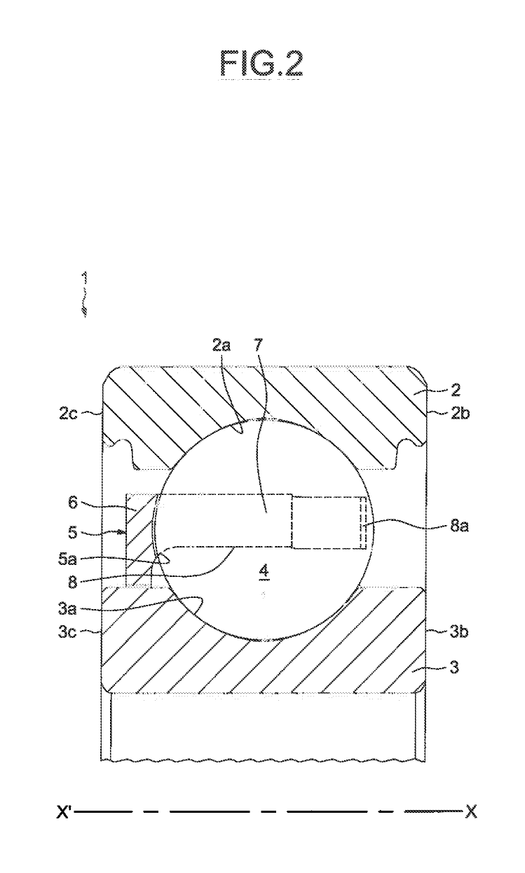

The rolling bearing, of axial axis X-X, referenced 1 overall in FIGS. 1 and 2, is intended to be mounted in a motor vehicle steering column.

As FIGS. 1 and 2 illustrate, the rolling bearing 1 comprises an outer ring 2, an inner ring 3, a row of rolling elements 4, in this instance produced in the form of balls, a cage 5 for maintaining the even circumferential spacing of the rolling elements 4.

The outer ring 2 and inner ring 3 are solid, what is meant by a “solid ring” is a ring the shape of which is obtained by machining with the removal of chips (turning, grinding) from tubes, bar stock, forged and/or rolled blanks.

The outer ring 2 comprises, at its bore, a deep-groove raceway 2a having, in cross section, a concave internal profile suited to the rolling elements 4, the raceway 2a facing radially inward. The inner ring 3 also comprises, on its cylindrical outer surface, a deep-groove raceway 3a which in cross section has a concave internal profile suited to the rolling elements 4, the raceway 3a being directed radially outward. The cage 5 is arranged radially between the outer surface of the inner ring 3 and the bore of the outer ring 2.

The inner and outer rings 3, 2 have radial frontal surfaces 3b, 3c, 2b, 2c that are substantially aligned and may each be produced as one by machining from a piece of steel.

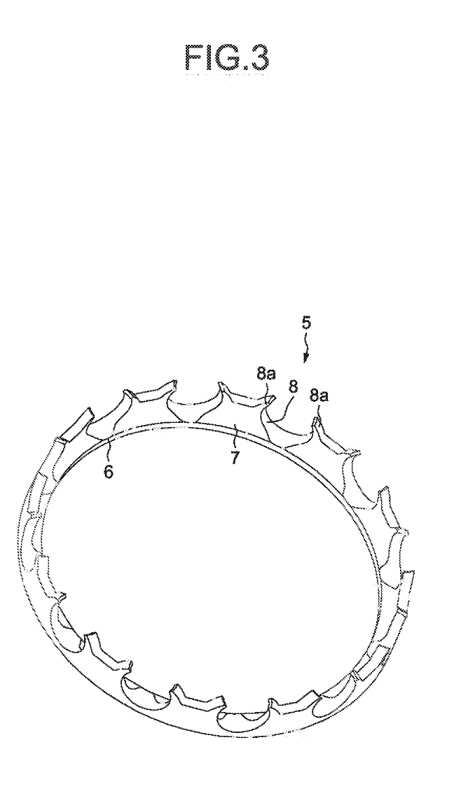

As visibly illustrated in FIGS. 2 and 3, the cage 5 comprises an annular portion 6 designed to be positioned axially on one side of the rolling elements 4 and that forms an annular heel, and dividing portions 7 or dividing fingers extending axially from the annular heel 6. The dividing portions 7 are as one with the annular heel 6 and between them delimit pockets 8 in which the rolling elements 4 are positioned and have a spherical overall shape that tends to envelop the associated rolling elements.

The dividing portions 7 take the form of pegs projecting axially with respect to the annular heel 6. The dividing portions 7 are delimited in the circumferential direction by lateral walls which define the pockets 8. The diameter of the cylinder defining the walls of each pocket 8 is greater than that of the rolling elements so that the rolling elements can be offered clearance in which to move radially and circumferentially with respect to the pockets 8. Each pocket 8 is open radially toward the inside and toward the outside and open axially on the opposite side to the annular heel 6 in order to allow the cage 5 to be fitted.

In the example illustrated in FIGS. 1 to 3, the dividing portion 7 has an inside diameter greater than the inside diameter of the annular heel 6, and an outside diameter substantially equal to the outside diameter of the annular heel 6, having in cross section the shape of an omega. Thus, at high levels of banking, the dividing portion 7 deforming toward the inside does not come into contact with the inner ring 3. In addition, the lubricant that has a tendency to flow toward the outside of the rolling bearing is retained radially by the dividing portion 7 of the cage 5.

Each dividing portion 7 comprises a claw 8a directed radially away from the annular heel 6 and the free end of which extends in the circumferential direction toward the claw 8a of the adjacent dividing portion 7 in order to form one of the substantially spherically shaped pockets 8 that tend to envelop a ball 4. The claws 8a form means of axial retention of the cage 5 on the rolling elements 4. The cage 5 comprises a connection 5a situated at the base of the dividing portion 7 and forms an interface between the annular heel 6 and the dividing portion 7. The connection 5a in cross section has a rounded profile.

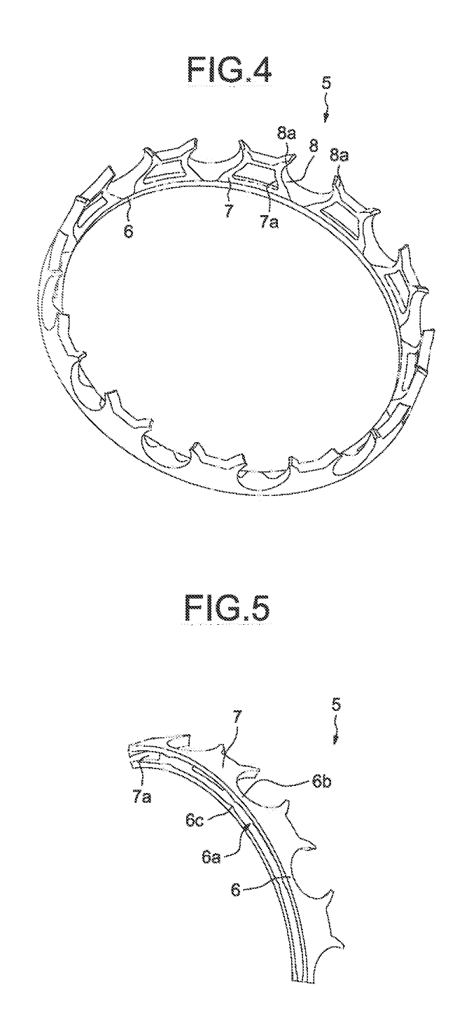

The embodiment illustrated in FIGS. 4 and 5, in which the same elements bear the same references, differs from the embodiment illustrated in FIGS. 1 to 3 through the presence of a recess 7a made on the internal face of the dividing portion 7, not opening radially to the outside. As an alternative, provision could be made for the recess 7a to open radially on each side of the cage 5. The annular heel 6 has an opening 6a in the thickness of the heel 6, opening axially between a face of the heel 6 which is the opposite face to the rolling elements 4, and the recess 7a of the dividing portions 7. As illustrated, the opening 6a is circumferential and is delimited radially between an outer part 6b of the heel 6 and an inner part 6c of the heel 6. As an alternative, the opening could be situated locally so as to open into the recess 7a of each dividing portion 7.

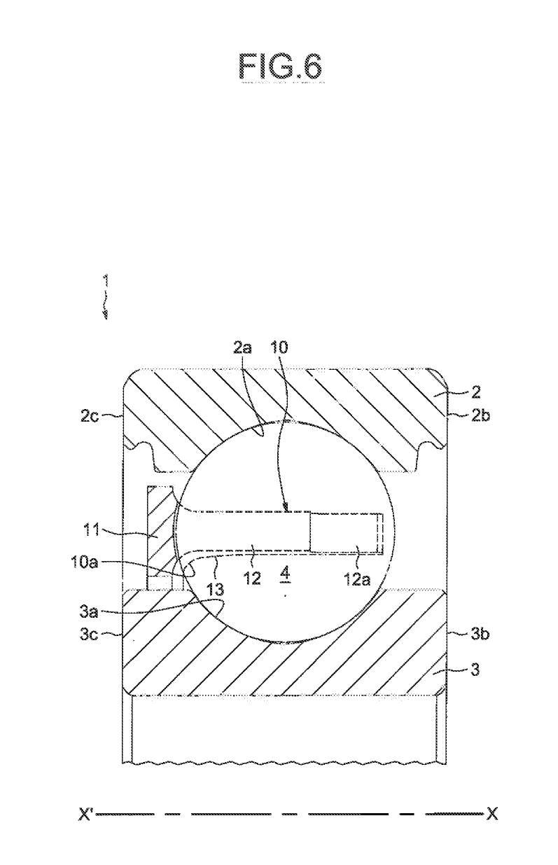

The embodiment illustrated in FIG. 6, in which the same elements bear the same references, differs from the embodiment illustrated in FIGS. 1 to 5 through the shape of the cage.

The cage 10 illustrated in FIG. 6 comprises an annular portion 11 arranged axially on one side of the rolling elements 4, forming an annular heel, and dividing portions 12 or dividing fingers extending axially from the annular heel 11. The dividing portions 12 are of one piece with the annular heel 11 and between them delimit pockets 13 in which the rolling elements 4 are arranged. The dividing portion 12 has an inside diameter greater than the inside diameter of the annular heel 11, and an outside diameter smaller than the outside diameter of the annular heel 11, in cross section having the shape of “T”. Thus, under steep banking, the dividing portion 12 deforming toward the inside does not come into contact with the inner ring 3. In addition, the lubricant, which has a tendency to flow toward the outside of the rolling bearing, is retained radially by the dividing portion 12 of the cage 10

Each dividing portion 12 comprises a claw 12a directed radially away from the annular heel 11 and the free end of which extends in the circumferential direction toward the claw 12a of the adjacent dividing portion 12 to form one of the pockets 13 of substantially spherical shape that tend to envelop a ball 4. The claws 12a form axial retention means for the axial retention of the cage 10 on the rolling elements 4. The cage 10 comprises a connection 10a situated at the base of the dividing portion 12 and forms an interface between the annular heel 11 and the dividing portion 12 and in cross section has a rounded profile.

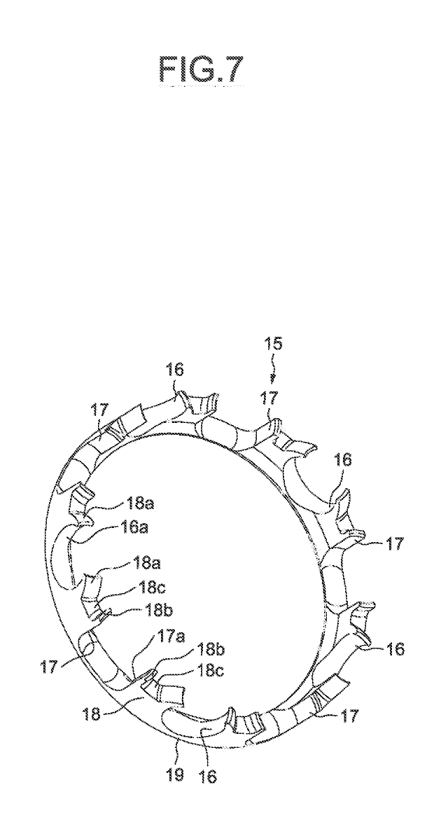

The embodiment illustrated in FIGS. 7 to 9, in which the same elements bear the same references, differs from the embodiment illustrated in FIGS. 1 to 5 through the shape of the cage.

The cage 15 comprises a plurality of first pockets 16 provided with axial retention means for the axial retention of the cage 15 on a rolling element 4 and a plurality of second pockets 17 which do not have axial retention means for the axial retention of the cage 15 on a rolling element 4. Each first pocket 16 is separated from a first pocket 16 by a second pocket 17. As an alternative, provision could be made for a plurality of first pockets 16 to follow on in succession and for the plurality of first pockets 16 to be separated from a first pocket 16 by a plurality of second pockets 17. The first pockets 16 are provided with substantially spherical walls and the second pockets 17 are provided with substantially cylindrical walls. A first pocket 16 is separated from an adjacent second pocket by a hybrid dividing portion 18 extending axially from an annular heel 19 arranged on one side of the rolling elements 4. The first pockets 16 are evenly distributed in the circumferential direction to ensure even axial retention of the cage 15 on the rolling elements 4.

The hybrid dividing portions 18 take the form of fingers or pegs projecting axially from the annular heel 19 and each having on one side in the circumferential direction a lateral wall 16a that is substantially spherical in order with an adjacent hybrid dividing portion 18 to form one of the first pockets 16 near a second pocket 17 and on the other side has a cylindrical wall 17a connecting to the cylindrical wall of the adjacent hybrid dividing portion 18 in order to form a second pocket 17.

Each hybrid dividing finger 18 comprises a claw 18a extending axially away from the annular heel 19 and the free end of which extends in the circumferential direction toward the opposite claw 18a of the adjacent hybrid dividing portion 18 to delimit the same first pocket 16. The concave interior surface of each claw 18a forms part of the spherical wall 16a of the pocket 16. The two claws 18a associated with a first pocket 16 extend toward one another, their free ends being spaced apart by a distance smaller than the diameter of the rolling elements 4. The claws 18a of a pocket 16 are capable of ensuring the axial retention of the cage 15 by clip-fastening onto the rolling element 4 arranged in the pocket 16. The cage 15 is retained axially on the row of rolling elements by the claws 18a.

Each hybrid dividing portion 18 also comprise an axial protuberance 18b of cylindrical shape extending axially away from the annular heel 19. The protuberance 18b of each hybrid dividing portion 18 delimits in part, with the protuberance 18b of the adjacent dividing portion 18, one of the second pockets 17 that does not have axial retention means. Each protuberance 18b is unable to provide axial retention of the cage 15 in relation to the rolling element 4 arranged in the second pocket 17 next to the first pocket 16. The cylindrical interior surface of the cylindrical protuberance 18b forms part of the cylindrical surface 17a of the second pocket 17.

The claw 18a and the protuberance 18b of each hybrid separation portion 18 are separated in the circumferential direction by a recess 18c so that the claw 18a has a relatively small circumferential thickness and a certain degree of flexibility allowing the cage 15 to be clip-fastened onto the rolling elements 4 through a circumferential parting of the claws 18a when an axial thrust is applied to the annular heel 19 of the cage 5 in the direction of the rolling elements 4. Each first pocket 16 is open radially toward the inside and towards the outside and is also open axially on the opposite side to the annular heel 19 in order to allow the cage 15 to be fitted.

As an alternative, when two first pockets 16 are adjacent, a first dividing finger comprising two claws 18a extending in opposite circumferential directions could be provided and when two second pockets 17 are adjacent, a second dividing finger comprising two cylindrical protuberances 18b could be provided.

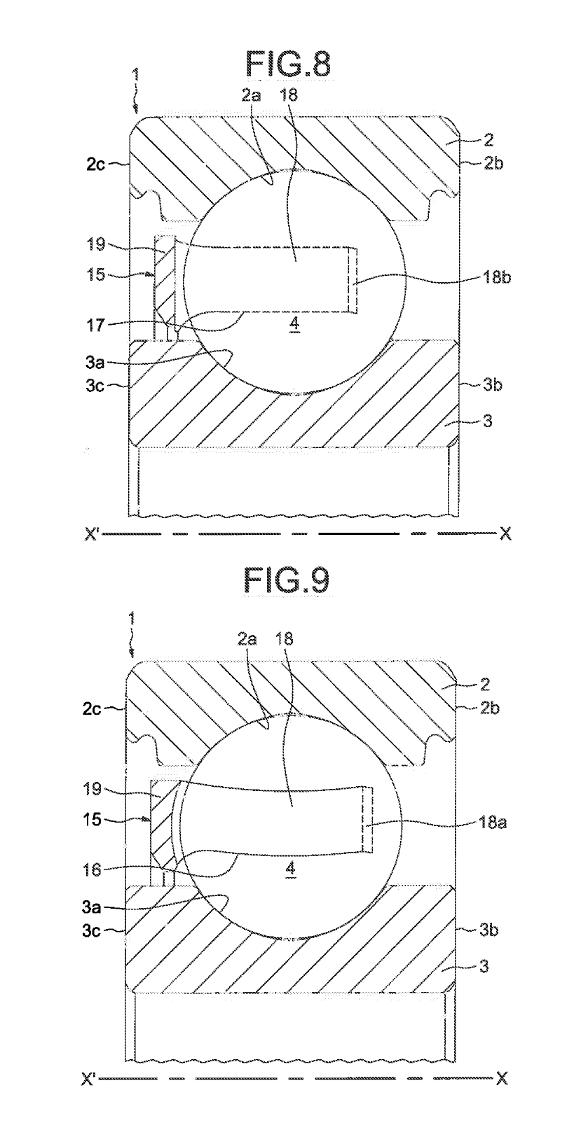

As illustrated in FIGS. 8 and 9, the dividing portion 18 in cross section has the shape of a gamma the outside diameter of which is substantially identical to the outside diameter of the annular heel 19 and the inside diameter of which is greater than the inside diameter of the annular heel 19.

In all the embodiments illustrated, the cage is advantageously made as a single piece, for example made of a synthetic material, preferably a polymer material, such as for example PA66, PA46, polyetheretherketone (PEEK), or a glass fiber reinforced polymer material. As an alternative, the cage is made of a metallic material such as brass, steel that is cast, sintered, machined, or by injection molding.

By virtue of the invention, the dividing portions, which have an inside diameter greater than the inside diameter of the heel, are not made to come into contact with the inner ring as the rolling bearing rotates. The cage therefore has an extended life.

In addition, the lubricant present in the rolling bearing is recovered by the projecting parts so that it can be distributed to the rolling elements.

1. A motor vehicle electric power steering rolling bearing cage intended to ensure the circumferential spacing of a row of rolling elements, comprising:
an annular heel extended axially by dividing portions between them defining pockets for the rolling elements opening radially on either side of the cage,
wherein the inside diameter of the dividing portions is greater than the inside diameter of the annular heel.

2. The cage as claimed in claim 1, wherein the outside diameter of the dividing portions is less than or equal to the outside diameter of the annular heel.

3. The cage as claimed in claim 1, comprising at least one first pocket provided with an axial retention feature for retention of the cage on a rolling element

4. The cage as claimed in claim 3, wherein the dividing portions situated between two adjacent first pockets comprise two claws, the free end of which extends in a circumferential direction toward the claw of the adjacent dividing portion to form one of the first pockets.

5. The cage as claimed in claim 3, comprising a plurality of second pockets that exclude the axial retention feature for retention of the cage on a rolling element.

6. The cage as claimed in claim 5, wherein the dividing portions situated between a first pocket and a second pocket comprise a claw, the free end of which extends in a circumferential direction toward the claw of the adjacent dividing portion to form one of the first pockets and a cylindrical protuberance forming, with the cylindrical protuberance of the adjacent dividing portion, one of the second pockets.

7. The cage as claimed in claim 1, wherein the dividing portions comprise a recess made on an internal face of the dividing portion.

8. The cage as claimed in claim 7, wherein the annular heel has an opening in the thickness of the heel opening axially between a face of the heel, which is the opposite face to the rolling elements, and the recess of the dividing portions.

9. The cage as claimed in claim 1, wherein the first pockets are provided with substantially spherical walls and the second pockets are provided with substantially cylindrical walls.

10. The cage as claimed in claim 1, wherein the cage is made of a synthetic material.

11. A rolling bearing comprising:
an outer ring comprising at least one outer ring raceway;
an inner ring comprising at least one inner ring raceway;
a row of rolling elements which are arranged between opposing outer and inner ring raceways of the at least one outer ring raceway and the at least one inner ring raceway; and
a cage, the cage comprising
an annular heel extended axially by dividing portions between them defining pockets for the rolling elements opening radially on either side of the cage,
wherein the inside diameter of the dividing portions is greater than the inside diameter of the annular heel.

12. A rolling bearing as claimed in claim 11, wherein the rolling elements are balls.

13. (canceled)

14. A rolling bearing as claimed in claim 11, wherein the rolling bearing is integrated into a motor vehicle electric power steering.

15. A rolling bearing as claimed in claim 12, wherein the rolling bearing is integrated into a motor vehicle electric power steering.

16. The cage as claimed in claim 1, wherein the cage is made of a polymer material.
